(19) United States
(12) Patent Application Publication
(10) Pub. No.: US 2021/0326612 A1
(43) Pub. Date: Oct. 21, 2021

(54) VEHICLE DETECTION METHOD AND DEVICE

(71) Applicant: SZ DJI TECHNOLOGY CO., LTD., Shenzhen (CN)

(72) Inventors: You ZHOU, Shenzhen (CN); Jianzhao CAI, Shenzhen (CN); Jiexi DU, Shenzhen (CN)

(21) Appl. No.: 17/358,999

(22) Filed: Jun. 25, 2021

Related U.S. Application Data
(63) Continuation of application No. PCT/CN2018/125800, filed on Dec. 29, 2018.

(51) Int. Cl. G06K 9/00; G06T 7/571; G06K 9/62

(52) U.S. Cl. CPC G06K 9/00825; G06T 7/571; G06K 9/6223; G06N 3/02; G06T 2207/10028; G06T 2207/30261; G06T 2207/20084; G06K 9/6272

(57) ABSTRACT

A vehicle detection method includes obtaining a target image and depth information of each pixel in the target image, obtaining a distance value of a vehicle candidate area in the target image according to the target image and the depth information, and determining a detection model corresponding to the vehicle candidate area according to the distance value of the vehicle candidate area.

### CROSS-REFERENCE TO RELATED APPLICATION

This application is a continuation of International Application No. PCT/CN2018/125800, filed Dec. 29, 2018, the entire content of which is incorporated herein by reference.

### TECHNICAL FIELD

The present disclosure relates to the field of image processing and, in particular, to a vehicle detection method and device.

### BACKGROUND

Automatic vehicle detection is one of indispensable content in self-driving and assisted driving technologies. Typically, an imaging device is provided at a vehicle. While the vehicle is running on a road, the imaging device captures images of vehicles on the road. A vehicle ahead can be automatically detected by a vehicle detection model through deep learning or machine learning of the images.

However, using a same vehicle detection model to detect the vehicle may lead to a relatively large probability of false detection or missed detection, resulting in a relatively low accuracy of vehicle detection.

### SUMMARY

In accordance with the disclosure, there is provided a vehicle detection method including obtaining a target image and depth information of each pixel in the target image, obtaining a distance value of a vehicle candidate area in the target image according to the target image and the depth information, and determining a detection model corresponding to the vehicle candidate area according to the distance value of the vehicle candidate area.

Also in accordance with the disclosure, there is provided a vehicle detection method including obtaining a target image, obtaining a vehicle candidate area in the target image, in response to determining that the vehicle candidate area includes a pair of taillights of a vehicle, obtaining a distance value of the vehicle candidate area according to a distance between the two taillights and a focal length of an imaging device that captured the target image, and determining a detection model corresponding to the vehicle candidate area according to the distance value of the vehicle candidate area.

### BRIEF DESCRIPTION OF THE DRAWINGS

FIG. 1 is a schematic flow chart of a vehicle detection method according to an example embodiment of the present disclosure.

FIG. 2 is a schematic diagram showing correspondence between a plurality of preset detection models and a plurality of preset distance value ranges according to an example embodiment of the present disclosure.

FIG. 3 is a schematic diagram showing a vehicle candidate area according to an example embodiment of the present disclosure.

FIG. 4 is a schematic flow chart of a vehicle detection method according to another example embodiment of the present disclosure.

FIG. 5 is a schematic diagram showing a principle of matching a taillight area according to an example embodiment of the present disclosure.

FIG. 6 is a schematic flow chart of a vehicle detection method according to another example embodiment of the present disclosure.

FIG. 7 is a schematic structural diagram of a vehicle detection device according to an example embodiment of the present disclosure.

### DETAILED DESCRIPTION OF THE EMBODIMENTS

Technical solutions of the present disclosure will be clearly described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

FIG. 1 is a schematic flow chart of a vehicle detection method according to an example embodiment of the present disclosure. An execution subject of the vehicle detection method consistent with the embodiments may include a vehicle detection device, which is applied to a scenario where a vehicle detection is performed on an image captured by an imaging device. The imaging device is provided at a device that can travel on a road, such as a vehicle, a driver-assistance device on a vehicle, a driving recorder mounted at a vehicle, a smart electric vehicle, a scooter, a balance vehicle, etc. In some embodiments, the vehicle detection device can be provided at the above-described device that can travel on the road. In some embodiments, the vehicle detection device may include the imaging device.

As shown in FIG. 1, the vehicle detection method includes following processes.

At S101, an image to be processed and depth information of each pixel in the image to be processed are obtained.

The image to be processed, also referred to as a “target image,” can be a two-dimensional image. The depth information of each pixel in the image to be processed can be a kind of three-dimensional information, which is used to indicate a distance between a spatial point represented by the pixel and the imaging device.

It should be noted the implementation manner of obtaining the depth information of the image is not limited here.

For example, the device traveling on the road can be provided with a lidar. Lidar ranging technology includes obtaining three-dimensional information of a scene through laser scanning. A basic principle of the lidar ranging technology includes launching a laser into a space, recording a time of a signal of each scanning point transmitting from the lidar to an object in a measured scene and then reflected from the object back to the lidar, and calculating a distance between a surface of the object and the lidar according to the recorded time.

As another example, the device traveling on the road can be provided with a binocular vision system or a monocular vision system. According to the principle of parallax, the imaging device is used to capture two images of a measured object from different positions, and a distance of the object is obtained by calculating a position deviation between corresponding points in the two images. In a binocular vision system, the two images can be captured by two imaging devices. In a monocular vision system, the two images can be captured at two different positions by the imaging device.

In some embodiments, obtaining the depth information of each pixel in the image to be processed in process S101 may include obtaining a radar map or a depth map corresponding to the image to be processed, matching the radar map or the depth map with the image to be processed to obtain the depth information of each pixel in the image to be processed.

At S102, a distance value of a vehicle candidate area (that is, a candidate area where a vehicle may be located) in the image to be processed is obtained according to the image to be processed and the depth information.

At S103, one or more detection models corresponding to the vehicle candidate area are determined according to the distance value of the vehicle candidate area.

Specifically, according to the image to be processed and the depth information of each pixel in the image, the vehicle candidate area is first obtained. The vehicle candidate area may or may not include a vehicle, which needs to be further determined by the detection model. It should be noted that the implementation of the detection model is not limited here. In some embodiments, the detection model may include a commonly used model in deep learning or machine learning. In some embodiments, the detection model may include a neural network model, for example, the convolutional neural network (CNN) model.

In an image, a size and position of an area occupied by objects with different distances and features displayed by the objects are different. For example, if a vehicle is relatively close to the imaging device, an area occupied by the vehicle in the image is relatively large and is usually located in a lower left or right corner of the image, which can display a door and a side area of the vehicle, etc. If the vehicle is in a medium distance to the imaging device, the area occupied by the vehicle in the image is relatively small and is usually located in a middle of the image, which can display a rear and a side area of the vehicle. If the vehicle is in a long distance to the imaging device, the area occupied by the vehicle in the image is much smaller and is usually located in a middle and upper part of the image, which can only display a small part of the rear of the vehicle.

Therefore, the distance value of the vehicle candidate area can be obtained according to the image to be processed and the depth information of each pixel in the image. The distance value can indicate a distance between a vehicle and the imaging device in a physical space. One or more detection models matching the distance value is obtained according to the distance value. Further, the one or more detection models are used to determine whether the vehicle candidate area includes a vehicle, thereby improving a detection accuracy.

It should be noted that the distance value of the vehicle candidate area is not limited here. For example, the distance value may include a depth value of any one pixel in the vehicle candidate area. As another example, the distance value may include an average value or a weighted average value determined according to the depth values of pixels in the vehicle candidate area.

It should be noted that a plurality of preset detection models are preset in an example embodiment. Each of the plurality of preset detection models corresponds to a certain preset distance value range. The preset distance value range corresponding to each of the plurality of preset detection models is not limited here. In some embodiments, there may be an overlapping area in the preset distance value ranges corresponding to two adjacent preset detection models.

The vehicle detection method consistent with the embodiments includes obtaining a distance value of a vehicle candidate area according to an image to be processed and depth information of each pixel in the image to be processed and determining one or more matching detection models according to the distance value, which improves the accuracy of the detection model. Compared with using a single model to detect vehicles, different detection models are used to detect vehicles according to different distances in the vehicle detection method consistent with the embodiments, which improves the accuracy and reliability of vehicle detection and reduces a probability of false detection and missed detection.

In some embodiments, the vehicle detection method consistent with the embodiments may further include determining whether the vehicle candidate area is a vehicle area using the one or more detection models corresponding to the vehicle candidate area.

In some embodiments, determining the one or more detection models corresponding to the vehicle candidate area according to the distance value of the vehicle candidate area in process S103 may include determining one or more preset detection models corresponding to one or more preset distance value ranges including the distance value of the vehicle candidate area (that is, the distance value of the vehicle candidate area is within each of the one or more preset distance value ranges) as the detection model corresponding to the vehicle candidate area according to correspondence between a plurality of preset distance value ranges and a plurality of preset detection.

In some embodiments, if a number of preset distance value ranges including the distance value of the vehicle candidate area is greater than 1, the preset detection model corresponding to each of the preset distance value ranges including the distance value of the vehicle candidate area is determined as one of the one or more detection models corresponding to the vehicle candidate area.

The correspondence between the preset detection model and the preset distance value range are illustrated below with examples.

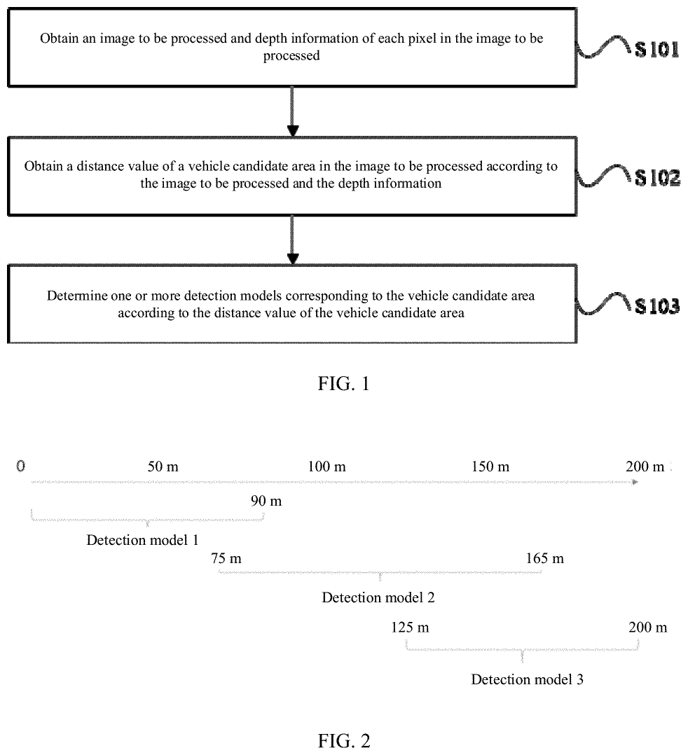

FIG. 2 is a schematic diagram showing correspondence between a plurality of preset detection models and a plurality of preset distance value ranges according to an example embodiment of the present disclosure. As shown in FIG. 2, three preset distance value ranges are preset within 200 meters. The preset distance value range of 0 to 90 meters corresponds to detection model 1, the preset distance value range of 75 to 165 meters corresponds to detection model 2, and the preset distance value range of 150 to 200 meters corresponds to detection model 3. There is an overlapping area in the distance value range between detection model 1 and detection model 2, which is specifically 75 to 90 meters. There is an overlapping area in the distance value range between detection model 2 and detection model 3, which is specifically 150 to 165 meters.

Assuming that the distance value of the vehicle candidate area is 50 meters, the one or more detection models corresponding to the vehicle candidate area include detection model 1. Assuming that the distance value of the vehicle candidate area is 80 meters, the one or more detection models corresponding to the vehicle candidate area include detection model 1 and detection model 2. Whether the vehicle candidate area includes a vehicle area can be determined using detection model 1 and detection model 2, respectively. Finally, the detection results of detection model 1 and detection model 2 are combined to determine whether the vehicle candidate area includes a vehicle area. For example, when it is determined that the vehicle candidate area includes a vehicle area by both detection model 1 and detection model 2, it is finally determined that the vehicle candidate area includes a vehicle area. As another example, when it is determined that the vehicle candidate area includes a vehicle area by either detection model 1 or detection model 2, it is finally determined that the vehicle candidate area includes a vehicle area.

It can be understood that the greater the number of preset distance value ranges, the smaller the interval of each preset distance value range, and the higher the precision for vehicle detection.

In some embodiments, obtaining the distance value of the vehicle candidate area in the image to be processed according to the image to be processed and the depth information in process S102 may include inputting the image to be processed into a first neural network model to obtain a road area in the image to be processed, performing cluster analysis on the pixels in the image to be processed according to the depth information to determine the vehicle candidate area adjacent to the road area in the image to be processed and obtain the distance value of the vehicle candidate area.

The first neural network model is used to obtain the road area in the image. A manner of representing the road area is not limited here. For example, the road area can be represented by a boundary line of the road. The boundary line of the road can be determined by a plurality of edge points of the road. As another example, the road area may include a plane area determined by the boundary line of the road.

The cluster analysis can be performed on the pixels in the image to be processed according to the depth information of each pixel in the image to be processed. The so-called cluster analysis refers to an analysis method that groups a collection of physical or abstract objects into a plurality of classes including similar objects. In an example embodiment, the cluster analysis is performed according to the depth information of the pixels, and the pixels at different positions in the image to be processed can be clustered to form a plurality of clusters. Then, the vehicle candidate area adjacent to the road area is determined among the plurality of clusters, and the distance value of the vehicle candidate area is obtained.

It should be noted that the implementation of the first neural network model is not limited here.

In some embodiments, the vehicle candidate area adjacent to the road area includes a vehicle candidate area whose minimum distance from pixels in the road area is less than or equal to a preset distance.

A specific value of the preset distance is not limited here.

In some embodiments, the distance value of the vehicle candidate area includes a depth value of a cluster center point of the vehicle candidate area.

It should be noted that a clustering analysis algorithm is not limited here.

The cluster analysis using K-means algorithm is taken as an example for illustration below.

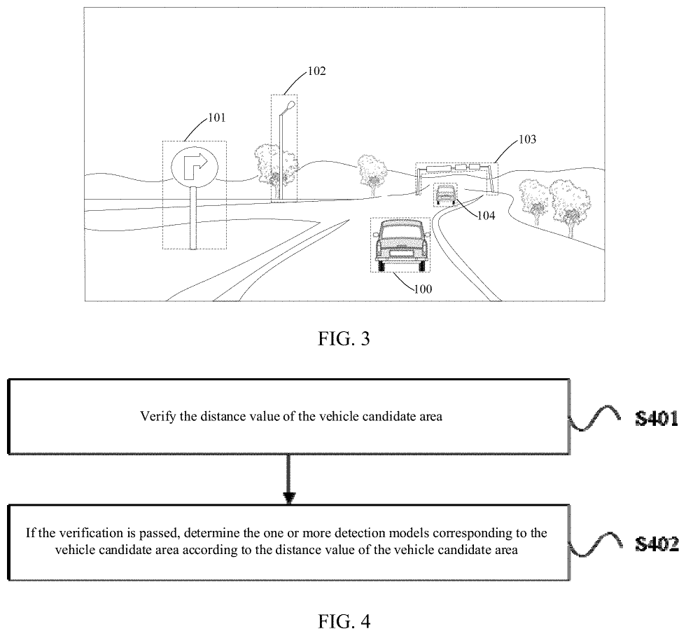

FIG. 3 is a schematic diagram showing a vehicle candidate area according to an example embodiment of the present disclosure. As shown in FIG. 3, the pixels in the image to be processed are traversed. K-means clustering is performed on each pixel according to a depth of the each pixel. For two points a and b, the corresponding depth values are Da and Db, respectively, and coordinates of points a and b in x-y coordinate plane are (Xa, Ya) and (Xb, Yb), respectively. Then, a distance function is:

Loss=(Da−Db)²+k((Xa−Xb)²+(Ya−Yb)²) (1)

where k is a positive number.

Through the k-means algorithm, the vehicle candidate areas adjacent to the road area are obtained as areas 100, 101, 102, 103, and 104, as shown in FIG. 3. The vehicle candidate areas may include vehicles, street signs, streetlights, and even grass, walls, etc., which are adjacent to the roads and conform to the cluster analysis results. The one or more detection models are used to further determine whether the vehicle candidate area includes a vehicle area.

The vehicle detection method consistent with the embodiments includes obtaining an image to be processed and depth information of each pixel in the image to be processes, obtaining a distance value of a vehicle candidate area according to the image to be processed and the depth information, and determining one or more detection models corresponding to the vehicle candidate area according to the distance value of the vehicle candidate area. The distance value of the vehicle candidate area is obtained and different detection models are used to detect vehicles according to different distance values in the vehicle detection method consistent with the embodiments, which improves the accuracy and reliability of vehicle detection and reduces a probability of false detection and missed detection.

FIG. 4 is a schematic flow chart of a vehicle detection method according to another example embodiment of the present disclosure. On the basis of the above-described embodiments, another implementation of the vehicle detection method consistent with the embodiments is provided. As shown in FIG. 4, in an example embodiment, before the one or more detection models corresponding to the vehicle candidate area are determined according to the distance value of the vehicle candidate area in process S103, the vehicle detection method further includes following processes.

At S401, the distance value of the vehicle candidate area is verified.

At S402, if the verification is passed, the one or more detection models corresponding to the vehicle candidate area are determined according to the distance value of the vehicle candidate area.

Specifically, before process S103 is performed, the distance value of the vehicle candidate area needs to be verified. Process S103 is performed only after the verification is passed. The accuracy of the distance value can be further determined by verifying the distance value. Therefore, the one or more detection models corresponding to the vehicle candidate area are determined according to the distance value, which further improves the accuracy of the one or more detection models.

In some embodiments, verifying the distance value of the vehicle candidate area in process S401 may include determining whether the vehicle candidate area includes a pair of taillights of a vehicle, if the vehicle candidate area includes a pair of taillights of the vehicle, obtaining a verification distance value of the vehicle candidate area according to a distance between the two taillights and a focal length of the imaging device, and determining whether a difference between the distance value of the vehicle candidate area and the verification distance value is within a preset difference range.

Specifically, if the vehicle candidate area includes a pair of taillights of the vehicle, it indicates that the vehicle candidate area includes a vehicle area. The so-called verification distance value refers to another distance value of the vehicle candidate area obtained using another calculation method through the distance between the two taillights of the vehicle. The distance value of the vehicle candidate area obtained according to the depth information of the pixels in the image to be processed is compared with the verification distance value obtained according to the distance between the taillights, whether the distance value of the vehicle candidate area is accurate can be determined. If the difference between the distance value of the vehicle candidate area and the verification distance value is within the preset difference range, the verification is passed. If the difference between the distance value of the vehicle candidate area and the verification distance value is not within the preset difference range, the verification is failed.

It should be noted that a specific value of the preset difference range is not limited here.

In some embodiments, the verification distance value is determined according to the focal length of the imaging device, a preset vehicle width, and a distance between outer edges of the two taillights.

In some embodiments, the verification distance value can be determined by formula (2):

Distance=focus_length*W/d (2)

where Distance represents the verification distance value, focus_length represents the focal length of the shooting device, W represents the preset vehicle width, and d represents the distance between the outer edges of the two taillights.

A specific value of the preset vehicle width is not limited here. For example, the value range of W can be 2.8-3 m.

In some embodiments, whether the vehicle candidate area includes a pair of taillights of the vehicle can be determined using existing image processing methods, such as image recognition and image detection.

Because the image processing method is relatively mature, determining whether the vehicle candidate area includes a pair of taillights of the vehicle using the image processing method can improve an accuracy of the determination.

In some embodiments, whether the vehicle candidate area includes a pair of taillights of the vehicle can be determined using a deep learning algorithm, a machine learning algorithm, or a neural network algorithm.

Because the deep learning algorithm, machine learning algorithm, or neural network algorithm trains models based on a large number of sample data, application scenarios are more extensive and comprehensive, thus improving the accuracy of determination.

In some embodiments, determining whether the vehicle candidate area includes a pair of taillights of the vehicle may include horizontally correcting the image to be processed to obtain a horizontally corrected image, and determining whether the vehicle candidate area includes a pair of taillights of the vehicle according to an area corresponding to the vehicle candidate area in the horizontally corrected image.

The image to be processed is first horizontally corrected, and then whether the vehicle candidate area includes a pair of taillights of the vehicle is determined, which eliminates an image error and improves the accuracy of determination.

It should be noted that there are many methods for horizontally correcting an image, which are not limited here.

For example, in an implementation manner, the image may be horizontally corrected according to a horizontal line of the imaging device to cause an x-axis direction of the image is parallel to the horizontal line.

The horizontal line of the imaging device is obtained by an inertial measurement unit (IMU) of the imaging device.

Assuming that an upper left corner of the image is an origin, a straight line equation of a horizon is shown in formula (3):

ax+by+c=0 (3)

where:

r=tan(pitch_angle)*focus_length (4)

a=tan(roll_angle) (5)

b=1 (6)

c=−tan(roll_angle)*Image_width/2+r*sin(roll_angle)*tan(roll_angle)−Image_height/2+r*cos(roll_angle) (7)

where focus_length represents the focal length, pitch_angle represents a rotation angle of a pitch axis, roll_angle represents a rotation angle of a roll axis, Image_width represents an image width, and Image_height represents an image height.

In some embodiments, determining whether the vehicle candidate area includes a pair of taillights of the vehicle according to the area corresponding to the vehicle candidate area in the horizontally corrected image may include inputting the area corresponding to the vehicle candidate area in the horizontally corrected image into a second neural network model and determining whether the vehicle candidate area includes a pair of taillights of the vehicle.

The second neural network model is used to determine whether the image includes a pair of taillights of the vehicle.

It should be noted that the implementation manner of the second neural network model is not limited here.

In some embodiments, if the second neural network model determines that the vehicle candidate area includes a pair of taillights of the vehicle, determining whether the vehicle candidate area includes a pair of taillights of the vehicle may also include obtaining a left taillight area and a right taillight area, obtaining a first area to be processed and a second area to be processed in the horizontally corrected image, obtaining a matching result, and determining whether the vehicle candidate area includes a pair of taillights of the vehicle according to the matching result. The first area to be processed includes the left taillight area, and the second area to be processed includes the right taillight area. The matching result can be obtained by horizontally flipping the left taillight area to obtain a first target area and performing image matching in the second area to be processed according to the first target area. Alternately, the matching result can be obtained by horizontally flipping the right taillight area to obtain a second target area and performing image matching in the first area to be processed according to the second target area.

The following is an example embodiment for illustration.

FIG. 5 is a schematic diagram showing a principle of matching a taillight area according to an example embodiment of the present disclosure. As shown in FIG. 5, a first area to be processed 203 is obtained based on a left taillight area (not shown), and a second area to be processed 202 is obtained based on a right taillight area 201. The right taillight area 201 is horizontally flipped to obtain a second target area 204. The image matching can be performed in the first area to be processed 203 according to the second target area 204 along a horizontal direction. In some embodiments, in an implementation manner, a distance between the second target area 204 and the left taillight area can be calculated. If the distance is less than a first preset threshold, it is determined that the image matching is successful. The vehicle candidate area includes a pair of taillights of the vehicle. In some embodiments, in another implementation manner, according to the second target area 204, a matching area closest to the second target area 204 is determined in the first area to be processed 203 along the horizontal direction. If a distance between the matching area and the second target area 204 is less than a second preset threshold, it is determined that the image matching is successful. The vehicle candidate area includes a pair of taillights of the vehicle.

Specific values of the first preset threshold and the second preset threshold are not limited here.

After the second neural network model is used to determine whether the vehicle candidate area includes a pair of taillights of the vehicle and the taillight area is obtained, the accuracy of determining whether the vehicle candidate area includes a pair of taillights of the vehicle is further improved by determining whether the taillight areas match.

In some embodiments, if the second neural network model determines that the vehicle candidate area includes a pair of taillights of the vehicle, determining whether the vehicle candidate area includes a pair of taillights of the vehicle may also include obtaining the taillight area of any taillight, horizontally flipping the taillight area to obtain a third target area, performing image matching in the horizontally corrected image according to the third target area to obtain a matching result, and determining whether the vehicle candidate area includes a pair of taillights of the vehicle according to the matching result.

A difference between this implementation manner and the above-described implementation manner is that after the taillight area is horizontally flipped, the area obtained by the horizontally flipping is directly used as a template for image matching. Thus, a calculation complexity is simplified, and a calculation efficiency is improved.

In some embodiments, performing the image matching in the horizontally corrected image according to the third target area to obtain the matching result may include performing the image matching in the horizontally corrected image on both sides of a horizontal direction with the third target area as a center, and obtaining a matching area closest to the third target area.

Specifically, the taillights on the vehicle are symmetrically arranged and located on a same horizontal line. The horizontally corrected image is an image been horizontally corrected, therefore performing the image matching on both sides of the horizontal direction with the third target area as the center can quickly find the matching area that matches the third target area with a closest distance, thereby improving a processing speed.

In some embodiments, determining whether the vehicle candidate area includes a pair of taillights of the vehicle according to the matching result may include determining that the vehicle candidate area includes a pair of taillights of the vehicle if a distance between the matching area and the taillight area is less than or equal to a preset threshold, or determining that the vehicle candidate area does not include a pair of taillights of the vehicle if the distance between the matching area and the taillight area is greater than the preset threshold.

Specifically, the matching area includes an area symmetrical to the taillight area determined by the image matching. The distance between the matching area and the taillight area should be approximately equal to the distance between the two taillights on the vehicle. Therefore, according to the distance between the matching area and the taillight area, it can be determined whether the vehicle candidate area includes a pair of taillights of the vehicle.

The vehicle detection method consistent with the embodiments includes verifying the distance value of the vehicle candidate area obtained according to the depth information of the pixels in the image to be processed, which can further determine the accuracy of the distance value. Therefore, the one or more detection models corresponding to the vehicle candidate area determined according to the distance value can further improve the accuracy of vehicle detection.

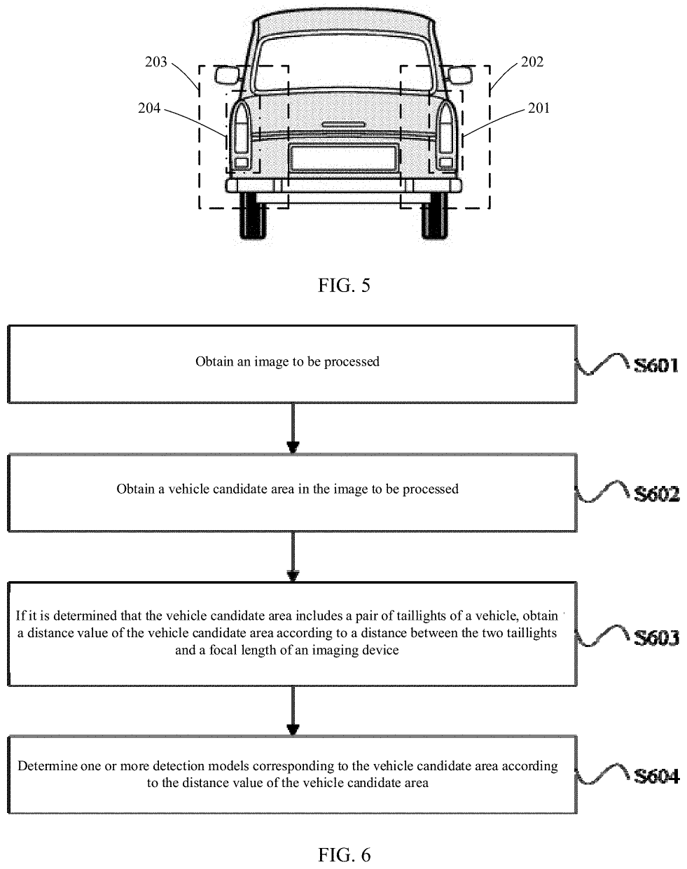

FIG. 6 is a schematic flow chart of a vehicle detection method according to another example embodiment of the present disclosure. In another example embodiment, an execution subject of the vehicle detection method may include a vehicle detection device, which is applied to a scenario where a vehicle detection is performed on an image captured by an imaging device. The imaging device is provided at a device that can travel on the road, such as a vehicle, a driver-assistance device on a vehicle, a driving recorder mounted at a vehicle, a smart electric vehicle, a scooter, a balance vehicle, etc. In some embodiments, the vehicle detection device can be provided at the above-described device that can travel on the road. In some embodiments, the vehicle detection device may include the imaging device.

As shown in FIG. 6, the vehicle detection method includes following processes.

At S601, an image to be processed is obtained.

At S602, a candidate vehicle area in the image to be processed is obtained.

At S603, if it is determined that the vehicle candidate area includes a pair of taillights of a vehicle, a distance value of the vehicle candidate area is obtained according to a distance between the two taillights and a focal length of the imaging device.

At S604, one or more detection models corresponding to the vehicle candidate area are determined according to the distance value of the vehicle candidate area.

In the vehicle detection method consistent with the embodiments, for the vehicle candidate area in the image to be processed, if the vehicle candidate area includes a pair of taillights of the vehicle, it indicates that the vehicle candidate area includes a vehicle area. The distance value of the candidate area of the vehicle is obtained by the distance between the two taillights on the vehicle. One or more matching detection models can be determined according to the distance value, which improves the accuracy of the detection model. Compared with using a single model to detect vehicles, different detection models are used to detect vehicles according to different distances in the vehicle detection method consistent with the embodiments, which improves the accuracy and reliability of vehicle detection and reduces a probability of false detection and missed detection.

It should be noted that the implementation manner of obtaining the vehicle candidate area in the image to be processed is not limited here. For example, the vehicle candidate area in the image to be processed can be obtained using image processing methods, deep learning, machine learning, or neural network algorithms.

In some embodiments, the vehicle detection method may further include determining whether the vehicle candidate area includes a vehicle area using the one or more detection models corresponding to the vehicle candidate area.

In some embodiments, the distance value is determined according to the focal length of the imaging device, a preset vehicle width, and a distance between outer edges of the two taillights.

In some embodiments, before it is determined that the vehicle candidate area includes a pair of taillights of the vehicle in process S603, the method further includes horizontal correcting the image to be processed to obtain a horizontally corrected image, and determining whether the vehicle candidate area includes a pair of taillights of the vehicle according to an area corresponding to the vehicle candidate area in the horizontally corrected image.

In some embodiments, determining whether the vehicle candidate area includes a pair of taillights of the vehicle according to the area corresponding to the vehicle candidate area in the horizontally corrected image may include inputting the area corresponding to the vehicle candidate area in the horizontally corrected image into a neural network model and determining whether the vehicle candidate area includes a pair of taillights of the vehicle.

In some embodiments, if the neural network model is used to determine whether the vehicle candidate area includes a pair of taillights of the vehicle, determining whether the vehicle candidate area includes a pair of taillights of the vehicle may also include obtaining a left taillight area and a right taillight area, obtaining a first area to be processed and a second area to be processed in the horizontally corrected image, obtaining a matching result, and determining whether the vehicle candidate area includes a pair of taillights of the vehicle according to the matching result. The first area to be processed includes the left taillight area, and the second area to be processed includes the right taillight area. The matching result can be obtained by horizontally flipping the left taillight area to obtain a first target area and performing image matching in the second area to be processed according to the first target area. Alternately, the matching result can be obtained by horizontally flipping the right taillight area to obtain a second target area and performing image matching in the first area to be processed according to the second target area.

In some embodiments, if the neural network model is used to determine whether the vehicle candidate area includes a pair of taillights of the vehicle, determining whether the vehicle candidate area includes a pair of taillights of the vehicle may also include obtaining the taillight area of any taillight, horizontally flipping the taillight area to obtain a third target area, performing image matching in the horizontally corrected image according to the third target area to obtain a matching result, and determining whether the vehicle candidate area includes a pair of taillights of the vehicle according to the matching result.

In some embodiments, performing the image matching in the horizontally corrected image according to the third target area to obtain the matching result may include performing the image matching in the horizontally corrected image on both sides of a horizontal direction with the third target area as a center, and obtaining a matching area closest to the third target area.

In some embodiments, determining whether the vehicle candidate area includes a pair of taillights of the vehicle according to the matching result may include determining that the vehicle candidate area includes a pair of taillights of the vehicle if a distance between the matching area and the taillight area is less than or equal to a preset threshold, or determining that the vehicle candidate area does not include a pair of taillights of the vehicle if the distance between the matching area and the taillight area is greater than the preset threshold.

In some embodiments, determining the one or more detection models corresponding to the vehicle candidate area according to the distance value of the vehicle candidate area in process S604 may include determining one or more preset detection models corresponding to one or more preset distance value ranges including the distance value of the vehicle candidate area as the one or more detection models corresponding to the vehicle candidate area according to correspondence between a plurality of preset distance value ranges and a plurality of preset detection models.

In some embodiments, there may be an overlapping area in the preset distance value ranges corresponding to two adjacent preset detection models.

It should be noted that, for a detailed description of the technical solution of the above-described embodiments, reference may be made to the description of the embodiments shown in FIG. 1 to FIG. 5. The “distance value of the vehicle candidate area” in the above-described embodiments is similar to the “verification distance value of the vehicle candidate area” in the embodiments shown in FIGS. 4 and 5. The “neural network model” in the above-described embodiments is similar to the “second neural network model” in the embodiments shown in FIGS. 4 and 5. The technical principles and technical effects are similar, which are omitted here.

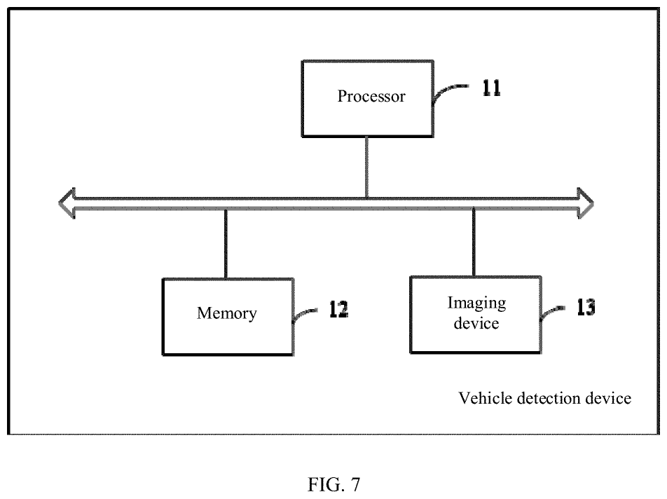

FIG. 7 is a schematic structural diagram of a vehicle detection device according to an example embodiment of the present disclosure. The vehicle detection device is used to implement the vehicle detection method consistent with the embodiments shown in FIG. 1 to FIG. 5. As shown in FIG. 7, the vehicle detection device includes a memory 12, a processor 11, and an imaging device 13. The imaging device 13 (a camera) is used to capture an image to be processed. The memory 12 stores a program code. The processor 11 is configured to execute the program code to obtain depth information of each pixel in the image to be processed, obtain a distance value of a vehicle candidate area in the image to be processed according to the image to be processed and the depth information, determine one or more detection models corresponding to the vehicle candidate area according to the distance value of the vehicle candidate area.

In some embodiments, the processor 11 is specifically configured to execute the program code to input the image to be processed into a first neural network model to obtain a road area in the image to be processed, perform cluster analysis on the pixels in the image to be processed according to the depth information to determine the vehicle candidate area adjacent to the road area in the image to be processed and obtain the distance value of the vehicle candidate area.

In some embodiments, the vehicle candidate area adjacent to the road area includes a vehicle candidate area with a minimum distance from pixels in the road area less than or equal to a preset distance.

In some embodiments, the processor 11 is specifically configured to execute the program code to perform cluster analysis using K-means algorithm.

In some embodiments, the distance value of the vehicle candidate area includes a depth value of a cluster center point of the vehicle candidate area.

In some embodiments, the processor 11 is specifically configured to execute the program code to determine one or more preset detection models corresponding to one or more preset distance value ranges including the distance value of the vehicle candidate area as the one or more detection models corresponding to the vehicle candidate area according to correspondence between a plurality of preset distance value ranges and a plurality of preset detection models.

In some embodiments, there is an overlapping area in the preset distance value ranges corresponding to two adjacent preset detection models.

In some embodiments, the processor 11 is also configured to execute the program code to verify the distance value of the vehicle candidate area and determine the one or more detection models corresponding to the vehicle candidate area according to the distance value of the vehicle candidate area if the verification is passed.

In some embodiments, the processor 11 is specifically configured to execute the program code to determine whether the vehicle candidate area includes a pair of taillights of a vehicle, obtain a verification distance value of the vehicle candidate area according to a distance between the two taillights and a focal length of an imaging device if the vehicle candidate area includes a pair of taillights of the vehicle, and determine whether a difference between the distance value of the vehicle candidate area and the verification distance value is within a preset difference range.

In some embodiments, the verification distance value is determined according to the focal length of the imaging device, a preset vehicle width, and a distance between outer edges of the two taillights.

In some embodiments, the processor 11 is specifically configured to execute the program code to horizontally correct the image to be processed to obtain a horizontally corrected image and determine whether the vehicle candidate area includes a pair of taillights of the vehicle according to an area corresponding to the vehicle candidate area in the horizontally corrected image.

In some embodiments, the processor 11 is specifically configured to execute the program code to input the area corresponding to the vehicle candidate area in the horizontally corrected image into a second neural network model and determine whether the vehicle candidate area includes a pair of taillights of the vehicle.

In some embodiments, if the second neural network model determines that the vehicle candidate area includes a pair of taillights of the vehicle, the processor 11 is further configured to execute the program code to obtain a left taillight area and a right taillight area, obtain a first area to be processed and a second area to be processed in the horizontally corrected image, obtain a matching result, and determine whether the vehicle candidate area includes a pair of taillights of the vehicle according to the matching result. The first area to be processed includes the left taillight area, and the second area to be processed includes the right taillight area. To obtain the matching result, the processor 11 is specifically configured to execute the program code to horizontally flip the left taillight area to obtain a first target area and perform image matching in the second area to be processed according to the first target area. Alternately, the processor 11 is specifically configured to execute the program code to horizontally flip the right taillight area to obtain a second target area and perform image matching in the first area to be processed according to the second target area.

In some embodiments, if the second neural network model determines that the vehicle candidate area includes a pair of taillights of the vehicle, the processor 11 is further configured to execute the program code to obtain the taillight area of any taillight, horizontally flip the taillight area to obtain a third target area, perform image matching in the horizontally corrected image according to the third target area to obtain a matching result, and determine whether the vehicle candidate area includes a pair of taillights of the vehicle according to the matching result.

In some embodiments, the processor 11 is specifically configured to execute the program code to perform the image matching in the horizontally corrected image on both sides of a horizontal direction with the third target area as a center, and obtain a matching area closest to the third target area.

In some embodiments, the processor 11 is specifically configured to execute the program code to determine that the vehicle candidate area includes a pair of taillights of the vehicle if a distance between the matching area and the taillight area is less than or equal to a preset threshold, or determine that the vehicle candidate area does not include a pair of taillights of the vehicle if the distance between the matching area and the taillight area is greater than the preset threshold.

In some embodiments, the processor 11 is specifically configured to execute the program code to obtain a radar map or a depth map corresponding to the image to be processed, match the radar map or the depth map with the image to be processed, and obtain the depth information of each pixel in the image to be processed.

The vehicle detection device consistent with the embodiments is used to implement the vehicle detection method consistent with the embodiments shown in FIGS. 1 to 5. The technical principles and technical effects are similar, which are omitted here.

FIG. 7 is a schematic structural diagram of a vehicle detection device according to an example embodiment of the present disclosure. The vehicle detection device is used to implement the vehicle detection method consistent with the embodiment shown in FIG. 6. As shown in FIG. 7, the vehicle detection device includes a memory 12, a processor 11, and an imaging device 13. The imaging device 13 is used to capture an image to be processed. The memory 12 stores a program code. The processor 11 is configured to execute the program code to obtain a vehicle candidate area in an image to be processed, if it is determined that the vehicle candidate area includes a pair of taillights of a vehicle, obtain a distance value of the vehicle candidate area according to a distance between the two taillights and a focal length of the imaging device, and determine one or more detection models corresponding to the vehicle candidate area according to the distance value of the vehicle candidate area.

In some embodiments, the distance value is determined according to the focal length of the imaging device, a preset vehicle width, and a distance between outer edges of the two taillights.

In some embodiments, the processor 11 is specifically configured to execute the program code to horizontally correct the image to be processed to obtain a horizontally corrected image and determine whether the vehicle candidate area includes a pair of taillights of the vehicle according to an area corresponding to the vehicle candidate area in the horizontally corrected image.

In some embodiments, the processor 11 is specifically configured to execute the program code to input the area corresponding to the vehicle candidate area in the horizontally corrected image into a neural network model and determine whether the vehicle candidate area includes a pair of taillights of the vehicle.

In some embodiments, if the neural network model is used to determine whether the vehicle candidate area includes a pair of taillights of the vehicle, the processor 11 is further configured to execute the program code to obtain a left taillight area and a right taillight area, obtain a first area to be processed and a second area to be processed in the horizontally corrected image, obtain a matching result, and determine whether the vehicle candidate area includes a pair of taillights of the vehicle according to the matching result. The first area to be processed includes the left taillight area, and the second area to be processed includes the right taillight area. To obtain the matching result, the processor 11 is specifically configured to execute the program code to horizontally flip the left taillight area to obtain a first target area and perform image matching in the second area to be processed according to the first target area. Alternately, the processor 11 is specifically configured to execute the program code to horizontally flip the right taillight area to obtain a second target area and perform image matching in the first area to be processed according to the second target area.

In some embodiments, if the neural network model is used to determine whether the vehicle candidate area includes a pair of taillights of the vehicle, the processor 11 is specifically configured to execute the program code to obtain the taillight area of any taillight, horizontally flip the taillight area to obtain a third target area, perform image matching in the horizontally corrected image according to the third target area to obtain a matching result, and determine whether the vehicle candidate area includes a pair of taillights of the vehicle according to the matching result.

In some embodiments, the processor 11 is specifically configured to execute the program code to perform the image matching in the horizontally corrected image on both sides of a horizontal direction with the third target area as a center and obtaining a matching area closest to the third target area.

In some embodiments, the processor 11 is specifically configured to execute the program code to determine that the vehicle candidate area includes a pair of taillights of the vehicle if a distance between the matching area and the taillight area is less than or equal to a preset threshold, or determine that the vehicle candidate area does not include a pair of taillights of the vehicle if the distance between the matching area and the taillight area is greater than the preset threshold.

In some embodiments, the processor 11 is specifically configured to execute the program code to determine one or more preset detection models corresponding to one or more preset distance value ranges including the distance value of the vehicle candidate area as the one or more detection models corresponding to the vehicle candidate area according to correspondence between a plurality of preset distance value ranges and a plurality of preset detection models.

In some embodiments, there is an overlapping area in the preset distance value ranges corresponding to two adjacent preset detection models.

The vehicle detection device consistent with the embodiments is used to implement the vehicle detection method consistent with the embodiments shown in FIG. 6. The technical principles and technical effects are similar, which are omitted here.

Those of ordinary skill in the art will appreciate that all or part of the processes in the above-described method embodiments can be implemented by a program instructing relevant hardware. The above-described program can be stored in a computer-readable storage medium. When the program is executed, the processes in the above-described method embodiments is executed. The storage medium can be any medium that can store program codes, for example, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A vehicle detection method comprising:
obtaining a target image and depth information of each pixel in the target image;
obtaining a distance value of a vehicle candidate area in the target image according to the target image and the depth information; and
determining a detection model corresponding to the vehicle candidate area according to the distance value of the vehicle candidate area.

2. The method of claim 1, wherein obtaining the distance value of the vehicle candidate area includes:
inputting the target image into a neural network model to obtain a road area in the target image;
performing cluster analysis on the pixels in the target image according to the depth information of the pixels to determine the vehicle candidate area adjacent to the road area in the target image and obtain the distance value of the vehicle candidate area.

3. The method of claim 2, wherein a minimum distance between the vehicle candidate area adjacent to the road area and pixels in the road area is less than or equal to a preset distance.

4. The method of claim 2, wherein performing the cluster analysis includes:
performing the cluster analysis using K-means algorithm.

5. The method of claim 2, wherein the distance value of the vehicle candidate area includes a depth value of a cluster center point of the vehicle candidate area.

6. The method of claim 1, wherein determining the detection model corresponding to the vehicle candidate area includes:
determining, according to a correspondence relationship between a plurality of preset distance value ranges and a plurality of preset detection models, one of the plurality of preset detection models corresponding to one of the plurality of preset distance value ranges that includes the distance value of the vehicle candidate area as the detection model corresponding to the vehicle candidate area.

7. The method of claim 6, wherein an overlapping area exists in the preset distance value ranges corresponding to two adjacent preset detection models.

8. The method of claim 1, further comprising, before determining the detection model corresponding to the vehicle candidate area:
performing a verification on the distance value of the vehicle candidate area;
wherein determining the detection model corresponding to the vehicle candidate area includes determining the detection model corresponding to the vehicle candidate area according to the distance value of the vehicle candidate area in response to the verification being passed.

9. The method of claim 8, wherein performing the verification on the distance value of the vehicle candidate area includes:
determining whether the vehicle candidate area includes a pair of taillights of a vehicle;
in response to the vehicle candidate area including the pair of taillights of the vehicle, obtaining a verification distance value of the vehicle candidate area according to a distance between the two taillights and a focal length of an imaging device that captured the target image; and
determining whether a difference between the distance value of the vehicle candidate area and the verification distance value is within a preset difference range.

10. The method of claim 9, wherein the verification distance value is determined according to the focal length of the imaging device, a preset vehicle width, and a distance between outer edges of the two taillights.

11. The method of claim 9, wherein determining whether the vehicle candidate area includes the pair of taillights of the vehicle includes:
horizontally correcting the target image to obtain a horizontally corrected image; and
determining whether the vehicle candidate area includes the pair of taillights of the vehicle according to an area corresponding to the vehicle candidate area in the horizontally corrected image.

12. The method of claim 11, wherein determining whether the vehicle candidate area includes the pair of taillights of the vehicle according to the area corresponding to the vehicle candidate area in the horizontally corrected image includes:
inputting the area corresponding to the vehicle candidate area in the horizontally corrected image into a neural network model to determine whether the vehicle candidate area includes a pair of taillights of the vehicle.

13. The method of claim 12, wherein determining whether the vehicle candidate area includes the pair of taillights of the vehicle further includes, in response to determining that the vehicle candidate area includes a pair of taillights of the vehicle using the neural network model:
obtaining a left taillight area and a right taillight area;
obtaining a first area to be processed and a second area to be processed in the horizontally corrected image, the first area to be processed including the left taillight area, and the second area to be processed including the right taillight area;
obtaining a matching result by at least one of:
horizontally flipping the left taillight area to obtain a first target area, and performing image matching in the second area to be processed according to the first target area; or
horizontally flipping the right taillight area to obtain a second target area, and performing image matching in the first area to be processed according to the second target area; and
determining whether the vehicle candidate area includes the pair of taillights of the vehicle according to the matching result.

14. The method of claim 12, wherein determining whether the vehicle candidate area includes the pair of taillights of the vehicle further includes, in response to determining that the vehicle candidate area includes a pair of taillights of the vehicle using the neural network model:
obtaining a taillight area;
horizontally flipping the taillight area to obtain a target area;
performing image matching in the horizontally corrected image according to the target area to obtain a matching result; and
determining whether the vehicle candidate area includes the pair of taillights of the vehicle according to the matching result.

15. The method of claim 14, wherein performing the image matching in the horizontally corrected image according to the target area to obtain the matching result includes:
performing the image matching in the horizontally corrected image on both sides of a horizontal direction with the target area as a center to obtain a matching area closest to the target area.

16. The method of claim 15, wherein determining whether the vehicle candidate area includes the pair of taillights of the vehicle according to the matching result includes:
in response to a distance between the matching area and the taillight area being less than or equal to a preset threshold, determining that the vehicle candidate area includes the pair of taillights of the vehicle; or
in response to the distance between the matching area and the taillight area being greater than the preset threshold, determining that the vehicle candidate area does not include the pair of taillights of the vehicle.

17. The method of claim 1, wherein obtaining the depth information of each pixel in the target image includes:
obtaining a radar map or a depth map corresponding to the target image; and
matching the radar map or the depth map with the target image to obtain the depth information of each pixel in the target image.

18. A vehicle detection method comprising:
obtaining a target image;
obtaining a vehicle candidate area in the target image;
in response to determining that the vehicle candidate area includes a pair of taillights of a vehicle, obtaining a distance value of the vehicle candidate area according to a distance between the two taillights and a focal length of an imaging device that captured the target image; and
determining a detection model corresponding to the vehicle candidate area according to the distance value of the vehicle candidate area.

19. The method of claim 18, wherein the distance value is determined according to the focal length of the imaging device, a preset vehicle width, and a distance between outer edges of the two taillights.

20. The method of claim 18, further comprising, before determining that the vehicle candidate area includes the pair of taillights of the vehicle:
horizontally correcting the target image to obtain a horizontally corrected image; and
determining whether the vehicle candidate area includes the pair of taillights of the vehicle according to an area corresponding to the vehicle candidate area in the horizontally corrected image.
